(19) United States
(12) Patent Application Publication
(10) Pub. No.: US 2006/0099839 A1
(43) Pub. Date: May 11, 2006

(54) Connector mounting structure

(76) Inventors: Yoshimitsu Ishida, Kasugai-shi (JP); Nobuaki Niki, Inuyama-shi (JP); Takahiro Nishiyama, Kasugai-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/265,775

(22) Filed: Nov. 2, 2005

(30) Foreign Application Priority Data
Nov. 5, 2004 (JP) 2004-323029
Nov. 1, 2005 (JP) 2005-318652

(51) Int. Cl. H01R 13/62

(52) U.S. Cl. 439/157

(57) ABSTRACT

A connector mounting structure has a fluid line component with a connecting hole, a connector mounted to the fluid line component and a positioning mechanism. The connector includes a connecting portion inserted in the connecting hole. The positioning mechanism is arranged between the connecting portion and the fluid line component. The positioning mechanism includes a first engaging portion in the connecting portion and a second engaging portion in the fluid line component. The first and the second engaging portions engage with one another so as to position the connecting portion relative to the connecting hole in the circumferential direction. The positioning mechanism allows to position the connecting portion relative to the connecting hole selectively at any one of a number of the mounting angular positions. The second engaging portion may be formed below the rim portion of an opening of the connecting hole.

### BACKGROUND OF THE INVENTION

1. Field of the Invention

The present invention relates to a connector mounting structure that is adapted for a connector used in a fluid piping of a motor vehicle or the like, for example, a connector mounting structure for mounting a connector to a fuel pump for a motor vehicle in order to connect a tube with the fuel pump.

2. Description of the Related Art

A gasoline fuel piping of a motor vehicle is constructed by connecting a tube with a fuel pump that is provided on a gasoline fuel tank. The tube is connected with the fuel pump in such manner or mode that a connecting hole is formed in a cap of the fuel pump, a tube is fitted on and connected to a quick connector, and the quick connector with the tube thereon is inserted in and connected to the connecting hole. The quick connector to be used for connecting the tube and the fuel pump integrally has a cylindrical connecting portion and the tube fit-on portion that is formed bent on one end or a distal end of the connecting portion. And, the tube, for example, made of resin is fitted on an outer circumference of the tube fit-on portion tightly.

To date, there have been some connector mounting structures for mounting a quick connector to a fuel pump, etc. For example, known is one disclosed in Patent Document 1 below. In the connector mounting structure of the Patent Document 1, a quick connector is mounted to the fuel pump, etc. so as to engage a stop detent formed on the quick connector with an annular stop portion that is provided on a circumference of a connecting hole formed in a cap of the fuel pump, etc. Therefore, this construction allows to minimize a length or height of a connecting member projecting from the cap, etc., and so on. However, this mounting structure is constructed without considering that an orientation of a tube fit-on portion is adjustable when the quick connector is mounted to the fuel pump, etc.. By the way, usually, the orientation of a tube extending or routing from the fuel pump, etc. varies according to a type of a motor vehicle. So, in the connector mounting structure of the Patent Document 1 that does not allow to adjust a mounting angle of a connecting portion of the quick connector relative to the connecting hole of the fuel pump, etc., sufficient versatility cannot be secured to meet piping constructions of various types of motor vehicles.

Accordingly, there is proposed another connector mounting structure wherein a quick connector is mounted to a fuel pump, etc. while being inserted in a connecting hole rotatably freely (for example, refer to Patent Document 2 below), or yet another connector mounting structure wherein a quick connector is mounted to a fuel pump, etc. while being inserted in a connecting hole rotatably in a predetermined angular extent (for example, refer to Patent Document 3 below).

| | |
|---|---|
| Patent Document 1 | JP, A, 2001-208265 |
| Patent Document 2 | JP, B, 2943722 |
| Patent Document 3 | JP, A, 2001-130581 |

However, in case where a quick connector is mounted to a fuel pump, etc. in rotatable relation or a rotatable state and an extending direction of a tube fit-on portion can vary, there is a fear that when a pressure of an internal fluid flowing in a tube changes drastically or a shock is brought from a motor vehicle body side, the tube swings and contacts or abuts with peripheral parts, resulting that the tube is damaged or broken. Therefore, the connector mounting structure as in the Patent Document 2 or 3 requires to provide additional construction for securing a piping.

### SUMMARY OF THE INVENTION

Accordingly, it is an object of the present invention to provide a novel connector mounting structure. The connector mounting structure of the present invention, for example, may be adapted for various piping arrangements, while securing a stable piping.

In order to achieve a foregoing object, there is provided the novel connector mounting structure comprising a fluid line component that is provided with a connecting hole, and a connector that is mounted to the fluid line component. A fluid line component means a device such as a fuel pump that is provided in a fluid piping or fluid line. The connector is inserted in (for example, plugged in) the connecting hole, and fixed to the fluid line component by a lock or stop mechanism so as not to come out of the connecting hole. The connector has a cylindrical connecting portion that is inserted in (for example, plugged in) and connected to the connecting hole and a tube fit-on portion that is formed bent on a distal end of the connecting portion (an axially outer end of the connecting portion). The tube fit-on portion means, for example, a portion to be fitted with a tubular body for fluid. The connector mounting structure further comprises a positioning mechanism that is arranged between the connecting portion of the connector and the fluid line component. Also, the positioning mechanism has a first engaging portion that is provided in the connecting portion of the connector and a second engaging portion that is provided in the fluid line component. The first engaging portion and the second engaging portion engage with one another in a circumferential direction so as to position the connector or the connecting portion of the connector nonrotatably relative to the connecting hole in the circumferential direction. The positioning mechanism is constructed to allow to position the connecting portion relative to the connecting hole in the circumferential direction selectively at any one of a number of mounting angular positions (mounting angular positions in the circumferential direction or mounting rotation angular positions), namely the positioning mechanism has a mounting angle adjustment function. The mounting angle adjustment mechanism or function allows to position the connecting portion in the circumferential direction selectively at any one of, for example, three or more mounting angular positions, or for example, four or more, five or more, or six or more mounting angular positions. The connecting portion of the connector may be inserted in and connected to the annular connecting hole. The first engaging portion and the second engaging portion engage with one another in the circumferential direction, for example, by inserting the connecting portion of the connector in the connecting hole.

For example, the second engaging portion may be formed in the connecting hole (for example, within the connecting hole) so as to be located on a rim or a rim portion of an opening of the connecting hole or below the rim or the rim portion of the opening. The rim or the rim portion of the opening is, for example, level with or generally level with a surface around a periphery of the opening. Or, for example, the second engaging portion may be formed in the connecting hole (for example, within the connecting hole) so as to be located on a position level with or generally level with a surface around a periphery of the opening of the connecting hole, or at lower level than the surface around the periphery of the opening. In this construction, it can be prevented that design or construction becomes complicate around a periphery of the connector that is mounted to the fluid line component. This helps, for example, a simple construction of a stop mechanism.

The connector connecting structure according to the present invention is constructed such that the first engaging portion and the second engaging portion engage with one another in the circumferential direction upon or by mounting or connecting the connector to the fluid line component so as to position the connecting portion of the connector in the circumferential direction. Therefore, as the connector is positioned nonrotatably relative to the connecting hole upon or by mounting the connector to the fluid line component, an extending direction of the tube fit-on portion, namely an orientation of the tube fit-on portion is not changed, for example, during driving. That is, the extending direction of the tube fit-on portion is kept in a certain direction. Further, provided is the mounting angle adjustment mechanism or function that allows to position the connecting portion of the connector relative to the connecting hole in the circumferential direction selectively at any one of a number of mounting angular positions. Thanks to the mounting angle adjustment mechanism or function, it becomes possible to mount the connector to the fluid line component while adjusting the extending direction or orientation of the tube fit-on portion by selecting the mounting angular position of the connecting portion. For example, the connecting portion of the connector is inserted in the connecting hole of the fluid line component at such mounting angle (mounting angle in the circumferential direction or mounting rotation angle) that the first engaging portion and the second engaging portion are consistent with one another in a circumferential position. Then, the first engaging portion and the second engaging portion engage with one another in the circumferential direction so as to position or directionally position the connecting portion in the circumferential direction. For example, eight mounting angles or mounting angular positions of the connecting portion where the first and second engaging portions are consistent with one another in the circumferential position are set in an angularly or circumferentially spaced relation, for example, in an equally circumferentially spaced relation at 45°.

In order to construct a simple positioning mechanism, the first engaging portion may be provided in an outer circumference of the connecting portion of the connector. And, the second engaging portion may be provided in the connecting hole or a circumference of an opening or outer opening of the connecting hole.

For example, the lock mechanism may be constructed to have an annular stop projecting portion that is formed on an outer circumference of the connecting portion of the connector, a retainer holding portion that is formed on a periphery of the opening of the connecting hole in the fluid line component, and a retainer that is located, for example, is disposed or plugged in between the retainer holding portion and the annular stop projecting portion that seats in a large-diameter fit-in portion formed in the opening or outer opening of the connecting hole in order to fix the annular stop projecting portion or in order to fix and lock or stop the annular stop projecting portion. The retainer may be constructed to be installed in the retainer holding portion after the connecting portion of the connector is inserted in and connected to the connecting hole, or may be connected to be installed before the connecting portion is inserted in and connected to the connecting hole. Or, the retainer may be constructed to be installed in the retainer holding portion both before and after the connecting portion of the connector is inserted in and connected to the connecting hole. The retainer is held in the retainer holding portion, for example, so as not to allow the connector to move in a retracting direction out of the connecting hole or disconnecting direction from the connecting hole. And, here, the large-diameter fit-in portion, in which the annular stop projecting portion seats, is formed in the opening of the connecting hole so as to allow the retainer to be smoothly located between the annular stop projecting portion and the retainer holding portion. In such arrangement, in order to facilitate inserting and connecting work of the connector, the first engaging portion is preferably provided on or adjacent to (or on a side of) a surface of the annular stop projecting portion facing the other end or a proximal end of the connecting portion or on the other side or proximal side (an axially inner surface of the annular stop projecting portion), and the second engaging portion is preferably provided in an annular bottom surface of the large-diameter fit-in portion of the connecting hole.

Here, the annular stop projecting portion seats in the large diameter fit-in portion, for example, so that a surface of the annular stop projecting portion facing a distal end of the connecting portion or on one side or a distal side (axially outer surface of the annular stop projecting portion) is co-planar with the surface around the periphery of the opening of the connecting hole. This construction helps ensure reliability of connecting work of the connector. The reason is as follows. For example, in order to meet a demand for compact sizing, there is a tendency that various components are crammed in a motor vehicle body, and thereby a joint area with the connector is not seldom located in a place surrounded by or behind the components. In such case, an operator cannot proceed with the connecting work while checking the joint area with the connector by visual observation. So, the annular projecting portion may be constructed to seat in the large diameter fit-in portion so that the surface of the annular stop projecting portion facing the distal end of the connecting portion is co-planar with the surface around the periphery of the opening of the connecting hole. In this construction, when the connector is not connected to the connecting hole correctly, the annular stop projecting portion is raised from the surface around the periphery of the opening. So, the lock mechanism may be constructed such that, when the annular stop projecting portion is raised from the surface around the periphery of the opening, the retainer abuts the annular stop projecting portion and the retainer cannot disposed or plugged in a predetermined position in the retainer holding portion. This construction allows the operator to check connecting status of the connector without visual observation and it may be surely prevented that connecting work is finished although the connector is not connected sufficiently.

Also, for example, the lock mechanism may be constructed to have an annular or generally annular retainer holding portion that is formed on a periphery of an opening or outer opening of the connecting hole in the fluid line component and provided with a passage aperture, and a retainer that is held in the retainer holding portion while engaging with the connecting portion that is inserted in and connected to the connecting hole through the passage aperture of the retainer holding portion to lock the connecting portion, for example, relative to the connecting hole. The retainer may be constructed to be installed in the retainer holding portion after the connecting portion of the connecter is inserted in and connected to the connecting hole, or may be constructed to be installed before the connecting portion is inserted in and connected to the connecting hole. Or, the retainer may be constructed to be installed in the retainer holding portion both before and after the connecting portion of the connector is inserted in and connected to the connecting hole. The retainer is held in the retainer holding portion, for example, so as not to allow the connector to move in a retracting direction out of the connecting hole or disconnecting direction from the connecting hole. In such arrangement, in order to facilitate inserting and connecting work of the connector, the second engaging portion to be engaged with the first engaging portion that is formed in an outer circumference of the connecting portion of the connector is preferably formed in the passage aperture of the retainer holding portion. The retainer may be constructed to be arranged to engage with the connecting portion after the connecting portion of the connector is inserted in and connected to the connecting hole. And, the retainer may be constructed to engage, for example, snappingly, with the connecting portion when the connecting portion of the connector is inserted in and connected to the connecting hole.

In order to secure a reliable anti-rotating function with a simple construction, the first engaging portion may be an engaging protrusion or engaging recessed portion, and the second engaging portion may be an engaging recessed portion or engaging protrusion to mate with or fit with the first engaging portion and engage with the first engaging portion in a circumferential direction. And, for example, a number of the engaging recessed portions may be arranged circularly or roundly to construct a mounting angle adjustment function. Or, the first engaging portion may be an engaging protrusion and the second engaging portion may be an engaging recessed portion to fit on the engaging protrusion and engage with the engaging protrusion in the circumferential direction. And, for example, engaging recessed portions may be formed in a number of positions circumferentially, for example, spaced apart, in the connecting hole or the opening or outer opening of the connecting hole, on a circumference of the connecting hole or the opening or outer opening of the connecting hole, in the annular bottom surface of the large-diameter fit-in portion, or around the passage aperture of the retainer holding portion. This arrangement allows to easily adjust a mounting angle of the tube fit-on portion by selecting the engaging recessed portion to fit the engaging protrusion in.

In the connector mounting structure according to the present invention, as already stated, the positioning mechanism, which is arranged between the connecting portion of the connector and the fluid line component, may be constructed to have an engaging protrusion that is provided in the connecting portion of the connector and an engaging recessed portion that is provided in the fluid line component. Here, the engaging protrusion and the engaging recessed portion engage with one another in a circumferential direction so as to position the connector or the connecting portion of the connector nonrotatably relative to the connecting hole in the circumferential direction. And, it is possible to construct the positioning mechanism such that a number of the engaging recessed portions are provided in the circumferential direction and the engaging protrusion engages with any one of the engaging recessed portions selectively. One engaging recessed portion to fit the engaging protrusion in is selected out of a number of engaging recessed portions and the connector is mounted to the fluid line component such that the engaging protrusion engages with or in the engaging recessed portion. In this manner, the connector may be mounted to the fluid line component while the tube fit-on portion is positioned in the circumferential direction so as to extend or orient in a proper direction. And, in this instance, for example, the engaging recessed portion may be formed also in the connecting hole (for example, within the connecting hole) so as to be located on a rim or a rim portion of an opening of the connecting hole or below the rim or the rim portion of the opening. The rim or the rim portion of the opening is level with or generally level with a surface around a periphery of the opening. The rim or the rim portion of the opening of the connecting hole is formed or arranged, for example, so as not to be raised outwardly from a surface of the circumference of the opening.

As described above, with the connector mounting structure of the present invention, for example, the connector may be mounted to a fuel line component while positioning the connector so as to orient the tube fit-on portion in a proper direction.

Now, the preferred embodiments of the present invention will be described in detail with reference to the drawings.

### BRIEF DESCRIPTION OF THE DRAWINGS

FIG. 1 is a perspective view to explain how to connect a quick connector to a fuel pump for a motor vehicle in a first connector mounting structure according to the present invention.

FIG. 2 is a sectional view showing the first connector mounting structure.

FIG. 3 is a side elevational view showing the first connector mounting structure.

FIG. 4 is a plan view showing a periphery of a connecting hole of the first connector mounting structure.

FIG. 5 is a view showing another sealing construction between a connecting portion of the quick connector and the connecting hole.

FIG. 6 is a sectional view showing a second connector mounting structure according to the present invention.

FIG. 7 is a side elevational view showing the second connector mounting structure.

FIG. 8 is a plan view showing a periphery of a connecting hole of the second connector mounting structure.

FIG. 9 is a sectional view showing a third connector mounting structure according to the present invention.

FIG. 10 is a side elevational view showing the third connector mounting structure.

FIG. 11 is a plan view showing a periphery of a connecting hole of the third connector mounting structure.

FIG. 12 is a sectional view to explain a small-diameter sealing portion formed in a connecting portion of a quick connector in the third connector mounting structure.

### DETAILED DESCRIPTION OF THE PREFERRED EMBODIMENTS

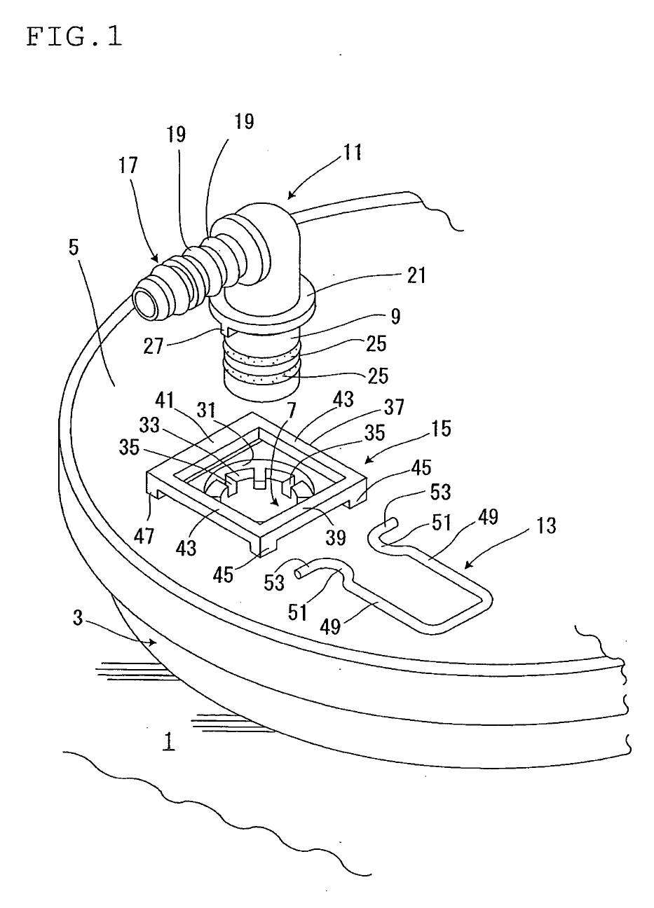

In a first connector mounting structure according to the present invention, as shown in FIG. 1, a fuel tank 1 for a motor vehicle is provided with a fuel pump 3 that has a cap 5, and this cap 5 is formed with a connecting hole 7 in which a connecting portion 9 of a tubular quick connector 11 is inserted. A wire retainer (wire-like retainer) 13 is held in a retainer holding portion 15. The retainer holding portion 15 is provided integrally on a circumference of an opening or outer opening of the connecting hole 7.

The quick connector 11 has a tube fit-on portion 17. The tube fit-on portion 17 is formed bent at 90°, namely bent just laterally on one end or a distal end of the connecting portion 9 (on an axially outer end of the connecting portion 9). The tube fit-on portion 17 is formed with a plurality of annular stop ribs 19 on an outer circumference or outer circumferential surface thereof. The quick connector 11 is integrally made of resin material such as fiber-reinforced polyamide (PA), polyacetal (POM) or fiber-reinforced POM. The tubular connecting portion 9 of the quick connector 11 is provided integrally with an annular stop projecting portion 21 like an outwardly directed flange on an axial center thereof. The tubular connecting portion 9 is formed with two annular fit-in grooves 23, 23 on an outer circumferential surface of a portion extending from the annular stop projecting portion 21 toward the other end or a proximal end of the connecting portion 9 (an axially inner end of the connecting portion 9). O-rings 25, 25 are fitted in the annular fit-in grooves 23, 23, respectively. The connecting portion 9 of the quick connector 11 is further formed integrally with an engaging piece 27 (a first engaging portion, an engaging protrusion) projecting radially outwardly, on one circumferential position on the outer circumferential surface thereof. An axially outer end of the engaging piece 27, which is located on a side of a distal end of the connecting portion 9, is connected to a surface of the annular stop projecting portion 21 facing the proximal end of the connecting portion 9 (an axially inner surface). A radially projecting length of the engaging piece 27 is equal to a radially projecting length of the annular stop projecting portion 21 so that a radially outer edge of the engaging piece 27 is consistent with an outer circumferential edge of the annular stop projecting portion 21 in a radial position. Here, exact one engaging piece 27 or exact one first engaging portion is provided. However, a plurality of the engaging pieces 27 or the first engaging portions may be provided on an outer circumferential surface of the connecting portion 9. In this case, the plurality of the engaging pieces 27 or the first engaging portions may be arranged in a diametrically symmetrical relation, or in an equally angularly spaced relation in a circumferential direction, for example, in a circumferentially spaced relation at 45°.

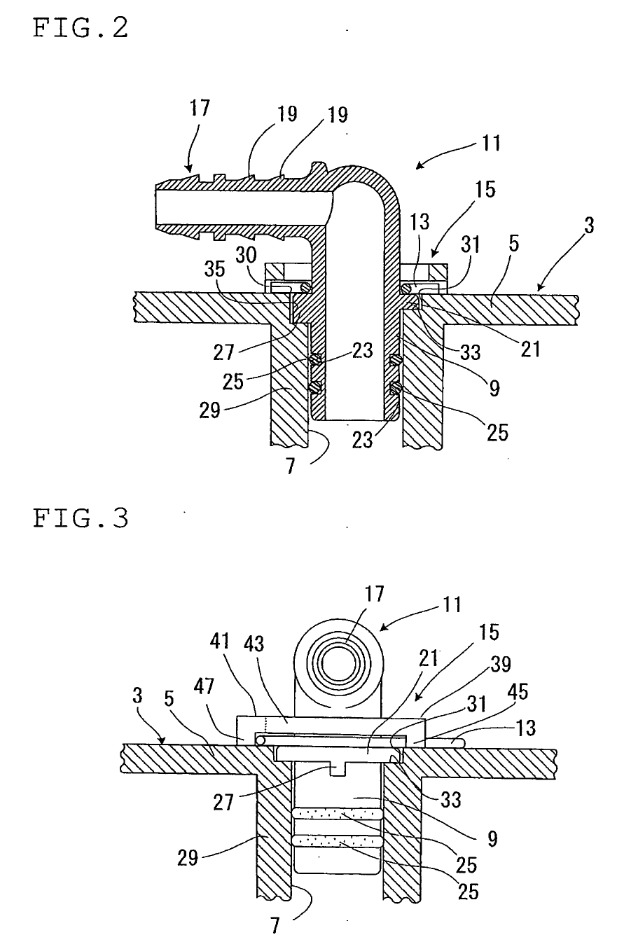

As shown in FIGS. 2 and 3, a cylindrical portion 29 is formed integrally in the cap 5 so as to project and extend inside the fuel tank 1, and the connecting hole 7 runs through from an outer surface or surface (flat surface) of the cap 5 to an inner end of the cylindrical portion 29. Namely, a rim 30 or a rim portion of the opening or outer opening of the connecting hole 7 is level with the outer surface of the cap 5. The connecting hole 7 has an inner diameter slightly larger than an outer diameter of the connecting portion 9 of the quick connector 11. An opening portion or opening of the connecting hole 7 defines a large diameter fit-in portion 31 on the cap 5. The fit-in portion 31 is designed to have an inner diameter slightly larger than an outer diameter of the annular stop projecting portion 21 of the quick connector 11 and a height or thickness generally equal to a thickness of the annular stop projecting portion 21.

An annular bottom surface 33 of the large diameter fit-in portion 31 of the connecting hole 7 is formed with eight engaging recesses (second engaging portions, engaging recessed portions) 35 equally spaced in a circumferential direction. These engaging recesses 35 are respectively configured to engage with engaging pieces 27 formed in the connecting portion 9 of the quick connector 11. That is, the engaging recesses 35 are formed below the rim 30 or the rim portion of the opening of the connecting hole 7, in and along the annular bottom surface 33 in a circumferentially spaced relation at 45° along an entire circumference thereof. Each of the engaging recesses 35 is provided across a full width of the annular bottom surface 33, and has a thickness generally equal to a thickness of the engaging piece 27 of the quick connector 11 and a depth generally equal to a height of the engaging piece 27.

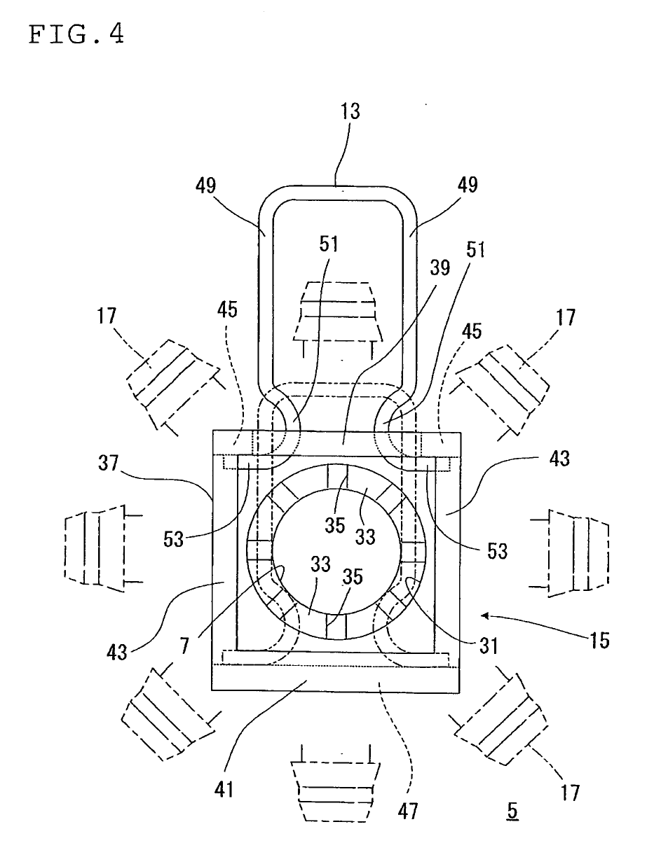

As understood from FIGS. 1 and 4, on an outer surface side of the cap 5, disposed is the retainer holding portion 15 that has a square frame body 37. The frame body 37 is constructed integrally by a one-side portion 39, an opposite-side portion 41 opposite the one-side portion 39, and a pair of lateral side portions 43, 43 that connect the one-side portion 39 and the opposite-side portion 41 at opposite ends thereof. The retainer holding portion 15 is configured such that the frame body 37 is arranged so as to be spaced slightly from the outer surface of the cap 5, and surrounds the fit-in portion 31 of the connecting hole 7 at an outer side or radially outer side of the fit-in portion 31. Support portions 45, 45 are formed integrally between opposite end portions of the one-side portion 39 of the frame body 37 and the outer surface of the cap 5 with height slightly larger than a diameter or wire diameter of the wire retainer 13. An opposite support portion 47 is also formed integrally between an outer side of the opposite-side portion 41 and the outer surface of the cap 5 so as to extend along an entire length of the opposite-side portion 41 at a height equal to that of the support portion 45. So, a gap slightly larger than or generally equal to the wire diameter of the wire retainer 13 is defined between the frame body 37 of the retainer holding portion 15 and the outer surface of the cap 5.

The wire retainer 13 is made by bending a metal wire or a metal wire member or molding resin material. The wire retainer 13 is formed in a horse shoe shape having a pair of arms 49, 49 on either side that extend parallel to one another. An inside distance (inside distance in a lateral direction) between the arms 49, 49 (middle portions of the arms 49, 49) is designed generally equal to an outer diameter of the connecting portion 9 of the quick connector 11. An outside distance (outside distance in the lateral direction) between the arms 49, 49 (the middle portions of the arms 49, 49) is designed slightly narrower or shorter than an inside distance between the support portions 45, 45 of the retainer holding portion 15. A leading end portion (free end portion) of each arms 49, 49 is bent laterally inwardly to form a curved portion (for example, generally semicircular curved portion) 51. And a guide retaining portion 53 extends laterally outwardly from each of leading ends of the curved portions 51. A distance between the leading ends of the arms 49, 49 (leading ends of the guide retaining portions 53, 53) is designed slightly larger than an inside distance between the lateral side portions 43, 43 of the retainer holding portion 15. The wire retainer 13 of such shape is installed or assembled in the frame body 37 by narrowing the distance between the guide retaining portions 53, 53 narrower than the inside distance between the support portions 45, 45 so as to allow the guide retaining portions 53, 53 to pass through between the one-side portion 39 and the outer surface of the cap 5 and pushing the guide retaining portions 53, 53 in the frame body 37. The guide retaining portions 53, 53 that are pushed in the frame body 37 resiliently return to their original shape so as to widen a distance therebetween until the leading end portions thereof are located between the lateral side portions 43, 43 and the outer surface of the cap 5. The wire retainer 13 that is installed in the frame body 37 is slidingly movable or slidable between a retracted position or released position (a position of the wire retainer 13 illustrated in a solid line in FIG. 4) wherein the guide retaining portions 53, 53 contact the support portions 45, 45, respectively and an engaged position or engaging position (a position of the wire retainer 13 illustrated in a phantom line in FIG. 4) wherein the guide retaining portions 53, 53 contact the support portion 47 and are located between the inner side of the opposite-side portion 41 and the outer surface of the cap 5. At the engaged position, rear end portions or rear ends of the arms 49, 49 (end portions or ends opposite to the free end portions) engage with the one-side portion 39 in a retracting direction, coming-out direction or disconnecting direction of the quick connector 11, the guide retaining portions 53, 53 engage with the opposite-side portion 41 in the retracting direction of the quick connector 11, and thereby the wire retainer 13 is stably held in a parallel relation to the frame body 37 so as not to be allowed to move in the retracting direction, coming-out direction, or disconnecting direction of the quick connector 11. Meanwhile, the wire retainer 13 is slidingly movable or slidable smoothly relative to the frame body 37 as the leading end portions of the guide retaining portions 53, 53 are positioned and guided between the lateral side portions 43, 43 and the outer surface of the cap 5.

The quick connector 11 is mounted to the cap 5 of the fuel pump 3 in a following manner. The connecting portion 9 of the quick connector 11 is inserted in the connecting hole 7 at such mounting angle as to orient the tube fit-on portion 17 in a predetermined direction while the wire retainer 13 is located in the retracted or released position, and the engaging piece 27 is fitted in the engaging recess 35 corresponding to the mounting angle determined here and engaged with the engaging recess 35 in the circumferential direction. In this state, the annular stop projecting portion 21 seats in the fit-in portion 31 and the outer surface or surface (flat surface) of the annular stop projecting portion 21 is level with the outer surface or surface of the cap 5. And, the quick connector 11 is locked against rotational movement (positioned in a circumferential direction) by circumferential engagement of the engaging piece 27 and the engaging recess 35 (positioning mechanism). Here, when the wire retainer 13 is moved to the engaged position, is inserted to the engaged position, the curved portions 51, 51 snap-engage with the connecting portion 9 of the quick connector 11 in a retracting or releasing direction, and thereby the wire retainer 13 is held in the engaged position. And, the annular stop projecting portion 21 engages with the arms 49, 49 of the wire retainer 13 in a retracting direction (coming-out or pull-out direction), and thereby the quick connector 11 is mounted to the fuel pump 3 in a locked relation or locked state. But, when, for example, the engaging piece 27 is not fitted in the engaging recess 35, and the annular stop projecting portion 21 is raised from the outer surface of the cap 5, as the curved portion 51 of the wire retainer 13 abuts the annular stop projecting portion 21, it is impossible or difficult to insert the wire retainer 13 in the retainer holding portion 15 sufficiently or properly. As shown in FIG. 4, orientation of the tube fit-on portion 17 may be adjusted by selecting the engaging recess 35 to fit the engaging piece 27 in and setting a mounting angle or a mounting angler position of the connecting portion 9 of the quick connector 11 (mounting angle adjustment mechanism or function). However, in this instance, if degree of freedom is given too much in orientation of the tube fit-on portion 17, it becomes difficult to orient the tube fit-on portion 17 quickly in the predetermined direction when connecting or assembling the quick connector 11. Therefore, the positioning mechanism may be constructed such that orientation of the tube fit-on portion 17 can be adjusted, for example, in up to sixteen directions, more preferably four to eight directions. Here, the orientation of the tube fit-on portion 17 may be adjusted in eight directions.

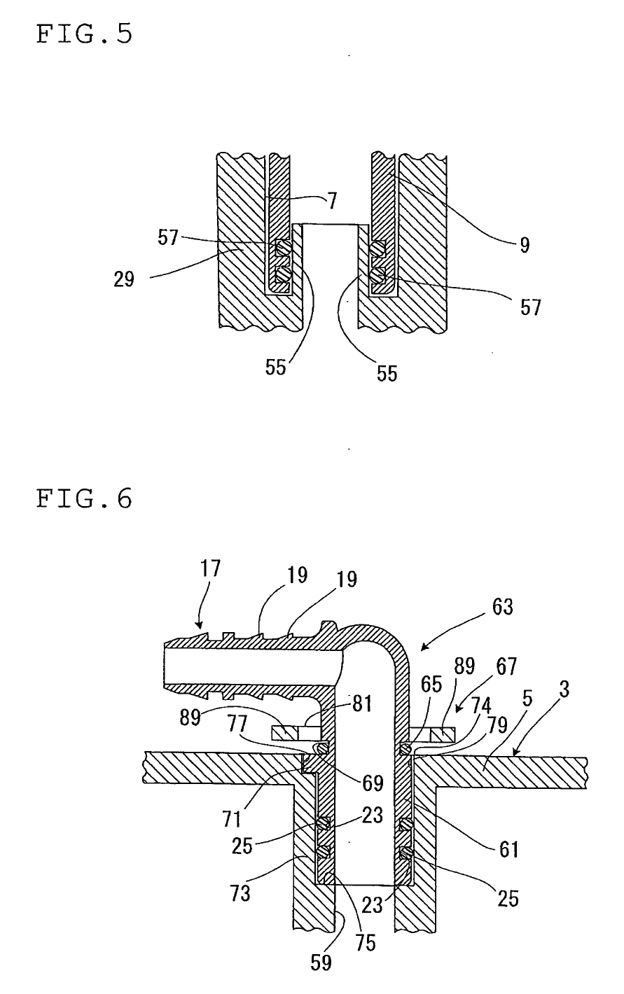

As shown in FIG. 5, an inner cylindrical portion 55 may be formed in the connecting hole 7 and the other end portion, a proximal end portion or an inner end portion of the connecting portion 9 of the quick connector 11 may be fitted on an outer circumference of the inner cylindrical portion 55 via O-rings 57, 57 to provide a seal between the connecting hole 7 and the connecting portion 9 inserted in the connecting hole 7.

In a second connector mounting structure according to the present invention as shown in FIG. 6, just like the first connector mounting structure, a fuel tank 1 (refer to FIG. 1) for a motor vehicle is provided with a fuel pump 3 that has a cap 5, and this cap 5 is formed with a connecting hole 59 in which a connecting portion 61 of a tubular quick connector 63 is inserted. A wire retainer (wire-like retainer) 65 is held in a retainer holding portion 67. The retainer holding portion 67 is provided integrally on a circumference of an opening or outer opening of the connecting hole 59. Generally, parts that have the same configuration in the first connector mounting structure are indicated by the same reference numerals, and will not be explained here.

The quick connector 63 has a tube fit-on portion 17. The tube fit-on portion 17 is formed bent at 90°, namely bent just laterally on a distal end of the connecting portion 61 (on an axially outer end of the connecting portion 61). The quick connector 63 is integrally made of resin material such as fiber-reinforced PA, POM or fiber-reinforced POM. The tubular connecting portion 61 of the quick connector 63 is provided with an annular stop groove 69 on an axial center thereof. An outer diameter of the connecting portion 61 is designed slightly larger at a proximal end portion or axially inner portion (a portion extending from the annular stop groove 69 to a proximal end of the connecting portion 61) than at a distal end portion (a portion extending from the annular stop groove 69 to a distal end of the connecting portion 61). The connecting portion 61 of the quick connector 63 is further formed integrally with an engaging piece 71 (a first engaging portion, an engaging protrusion) projecting radially outwardly, on one circumferential position on an outer circumferential surface thereof. An axially outer end of the engaging piece 71 that is located on a side of a distal end of the connecting portion 61 is designed to be located at the same axial position as an axially inner wall surface of the annular stop groove 69 that is located on a side of a proximal end of the connecting portion 61. Here, exact one engaging piece 71 or exact one first engaging portion is provided. However, a plurality of the engaging pieces 71 or the first engaging portions may be provided on an outer circumferential surface of the connecting portion 61. In this case, the plurality of the engaging pieces 71 or the first engaging portions may be arranged in a diametrically symmetrical relation, or in an equally angularly spaced relation in a circumferential direction, for example, in a circumferentially spaced relation at 45°.

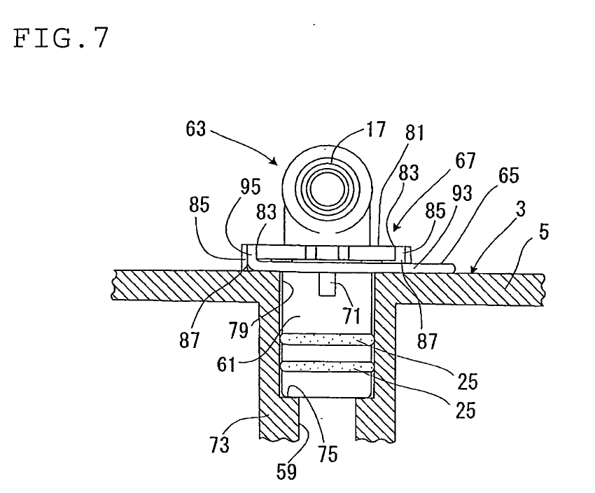

As shown in FIGS. 6 and 7, a cylindrical portion 73 is formed integrally in the cap 5 so as to project and extend inside the fuel tank 1 or so as to project inside in order to pump a fuel from the fuel tank 1, and the connecting hole 59 runs through from an outer surface or surface of the cap 5 to an inner end of the cylindrical portion 73. Namely, a rim 74 of the opening or outer opening of the connecting hole 59 is level with the outer surface of the cap 5. The connecting hole 59 has an inner diameter slightly larger than an outer diameter of the proximal end portion of the connecting portion 61 on an outer portion near (toward) its opening or outer opening, smaller than the outer diameter of the proximal end portion of the connecting portion 61 on an inner portion away from the opening or outer opening, and an annular abutment surface 75 that is defined on an axially intermediate position, namely between the outer portion and the inner portion of the connecting hole 59 for stopping further forward movement of the quick connector 63. The outer surface of the cap 5 is formed with eight engaging recesses (second engaging portions, engaging recessed portions) 77 around the opening of the connecting hole 59 or on a circumference of the opening of the connecting hole 59. The engaging recesses 77 are configured to engage with engaging piece 71 formed in the connecting portion 61 of the quick connector 63, respectively, and are arranged equally spaced in a circumferential direction. That is, the engaging recesses 77 are formed in a circumferentially spaced relation at 45° around the opening of the connecting hole 59 along an entire circumference thereof. Each of the engaging recesses 77 is formed so as to open at the outer surface of the cap 5 and in an inner circumferential surface 79 of the opening or opening portion of the connecting hole 59 (therefore, the engaging recesses 77 are formed in or within the connecting hole 59 and on the rim 74 or the rim portion of the opening of the connecting hole 59), extends radially for a length or radial length generally equal to a projecting length of the engaging piece 71, and has a thickness generally equal to that of the engaging piece 71 and a depth generally equal to the height of the engaging piece 71.

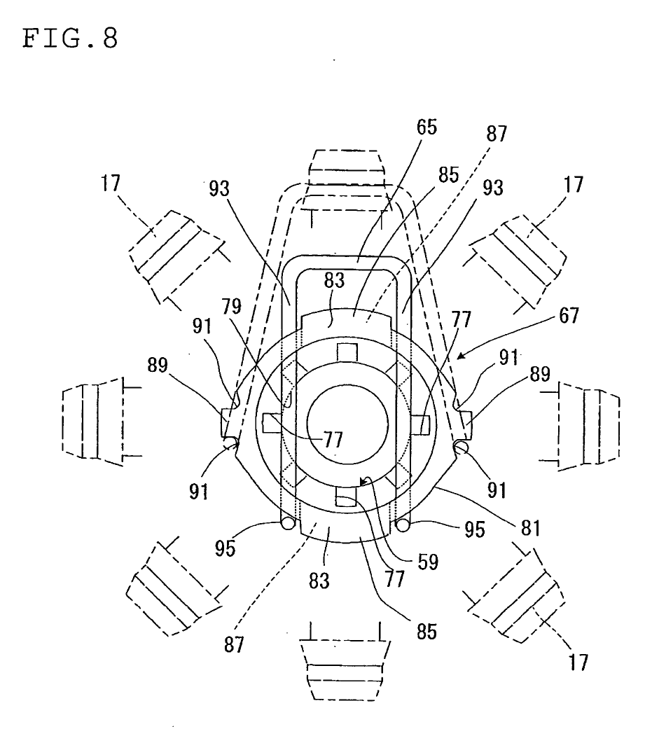

As understood from FIG. 8, on an outer surface side of the cap 5, disposed is the retainer holding portion 67 that has a ring-shaped frame body (annular body or annular frame body) 81. The retainer holding portion 67 is configured such that the ring-shaped frame body 81 is arranged so as to be spaced slightly from the outer surface of the cap 5, and surrounds the connecting hole 59 and the engaging recesses 77 at a radially outer side of the connecting hole 59 and the engaging recesses 77. The ring-shaped frame body 81 has a pair of positioning portions 83, 83 in a diametrically symmetrical positions. Each of the positioning portions 83, 83 includes an outer rim portion 85 that extends or projects radially outwardly. Positioning support portions 87, 87 are formed integrally between the positioning portions 83, 83 and the outer surface of the cap 5 across entire areas of the positioning portions 83, 83 with height slightly greater than a wire diameter of the wire retainer 65. So, a gap slightly larger than or generally equal to the wire diameter of the wire retainer 65 is defined between the ring-shaped frame body 81 of the retainer holding portion 67 and the outer surface of the cap 5. Further, an outer circumferential rim of the ring-shaped frame body 81 is formed with stoppers 89, 89 extending or projecting radially outwardly, on middle portions between the positioning portions 83, 83, and retaining recessed portions 91, 91 on either circumferential side of a base of the stopper 89.

The wire retainer 65 is made by bending a metal wire or a metal wire member or molding resin material. The wire retainer 65 is formed in a horse shoe shape having a pair of arms 93, 93 on either side that extend parallel to one another. An inside distance (inside distance in a lateral direction) between the arms 93, 93 is designed generally equal to an outer diameter of the annular stop groove 69 formed in the connecting portion 61 of the quick connector 63 and a width of the positioning portion 83 of the ring-shaped frame body 81. A leading end portion (free end portion) of each of the arms 93, 93 is bent in a direction perpendicular to a virtual plane including the arms 93, 93 to form a guide engaging portion 95. The wire retainer 65 of such shape is arranged or assembled between the ring-shaped frame body 81 and the outer surface of the cap 5 such that rear end sides or rear end portions (ends or end portions opposed to the free ends) of the arms 93, 93 hold one positioning support portion 87 therebetween, and the guide engaging portions 95, 95 hold the other positioning support portion 87 and the outer rim portion 85 of the other positioning portion 83 (engaged or engaging position: refer to a position of the wire retainer 65 illustrated in a solid line in FIG. 8). When the wire retainer 65 is pulled out in a pull-out direction (direction from the other positioning portion 83 toward the one positioning portion 83), the guide engaging portions 95, 95 slide along the outer circumferential rim of the ring-shaped frame body 81 from the positioning portions 83, 83 to the stoppers 89, 89, respectively, and the wire retainer 65 is displaced in a retracted or released position (refer to a position of the wire retainer 65 illustrated in a phantom line in FIG. 8) wherein the arms 93, 93 are widen or spread apart to be located outside the connecting hole 59 and the engaging recesses 77. When the wire retainer 65 is displaced to the released position, as the guide engaging portions 95, 95 move to the stoppers 89, 89 and seat in the retaining recessed portions 91, 91, the wire retainer 65 is held in the released position. And, when a large push-in force (force in a direction from the one positioning portion 83 toward the other positioning portion 83) is exerted to the wire retainer 65, the guide engaging portions 95, 95 of the arms 93, 93 get out of the retaining recessed portions 91, 91, respectively, and smoothly slide along the outer circumferential rim of the ring-shaped frame body 81 to the other positioning support portion 87 and the outer rim portion 85 of the other positioning portion 83 under the force cooperating with a spring back force of the arms 93, 93 to their original parallel state, and consequently, the wire retainer 65 returns to the engaged position. At the engaged position, rear end portions and leading end portions of the arms 93, 93 engage with the ring-shaped frame body 81 in a retracting direction, coming-out direction or disconnecting direction of the quick connector 63, the wire retainer 65 is stably held in a parallel relation or state to the ring-shaped frame body 81 so as not to be allowed to move in the retracting direction of the quick connector 63. Meanwhile, the ring-shaped frame body 81 is shaped symmetric relative to a straight line passing through the stoppers 89, 89, the wire retainer 65 may be installed in the ring-shaped frame body 81 from a side of the other positioning portion 83 toward the one positioning portion 83.

The quick connector 63 is mounted to the cap 5 of the fuel pump 3 in a following manner. The connecting portion 61 of the quick connector 63, more specifically, the proximal end portion of the connecting portion 61 extending from the annular stop groove 69 in a proximal direction is inserted in the outer portion or outer end portion of the connecting hole 59 at such mounting angle as to orient the tube fit-on portion 17 in a predetermined direction, while the wire retainer 65 is located in the retracted or released position. The connecting portion 61 is inserted in the connecting hole 59 until an inner end of the connecting portion 61 abuts the annular abutment surface 75 of the connecting hole 59 and the engaging piece 71 is fitted in the engaging recess 77 corresponding to the mounting angle determined here so as to engage with the engaging recess 77 in a circumferential direction. In this state, the axially inner wall surface of the annular stop groove 69 is level with the outer surface of the cap 5. An axially outer end of the engaging piece 71 is also level with the outer surface of the cap 5. And, the quick connector 63 is locked against rotational movement (positioned in a circumferential direction) by circumferential engagement of the engaging piece 71 and the engaging recess 77 (positioning mechanism). Here, when the wire retainer 65 is moved or displaced to the engaged position, the arms 93, 93 of the wire retainer 65 enter in the annular stop groove 69 formed in the connecting portion 61 of the quick connector 63, the annular stop groove 69 engages with the arms 93, 93 in a retracting or coming-out direction, and thereby the quick connector 63 is mounted to the fuel pump 3 in a locked relation or locked state. Also in the second connector mounting structure, as shown in FIG. 8, orientation of the tube fit-on portion 17 of the quick connector 63 may be adjusted by selecting the engaging recess 77 to fit the engaging piece 71 in and setting a mounting angle or a mounting angular position of the connecting portion 61 of the quick connector 63 (mounting angle adjustment mechanism or function). The positioning mechanism may be constructed such that orientation of the tube fit-on portion 17 is adjustable, for example, in up to sixteen directions, more preferably four to eight directions. Here, the orientation of the tube fit-on portion 17 may be adjusted in eight directions.

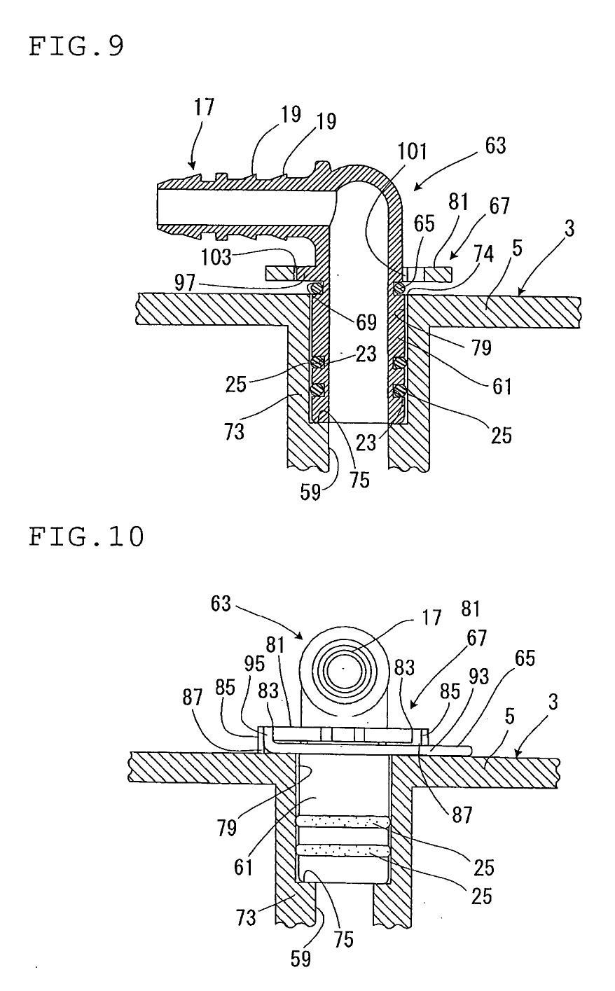

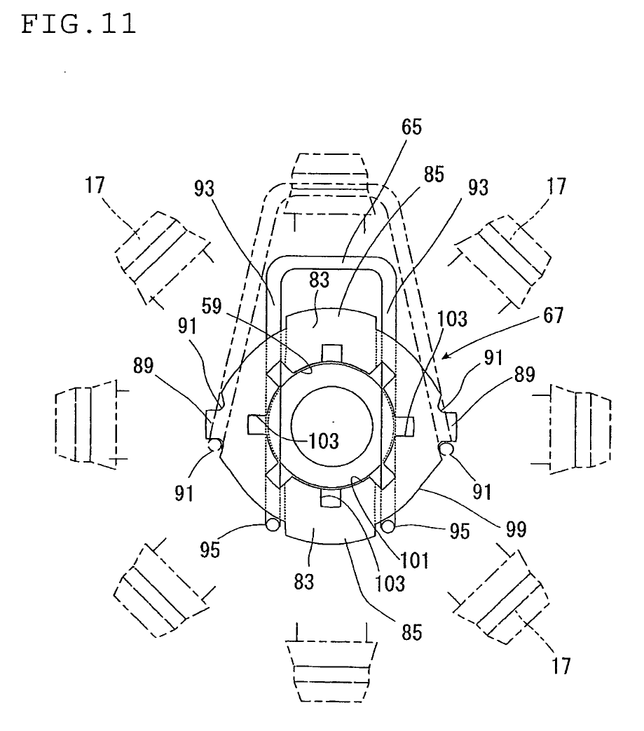

A third connector mounting structure according to the present invention, as shown in FIG. 9, is constructed by modifying a rotational movement stop mechanism or positioning mechanism of the second connector mounting structure, and otherwise the same as the second connector mounting structure. Therefore, generally, parts that have the same configuration in the second connector mounting structure are indicated by the same reference numerals, and will not be explained here.

In the third connector mounting structure, the connecting portion 61 is formed with an engaging piece 97 (a first engaging portion, an engaging protrusion) projecting radially outwardly, on an outer circumferential surface thereof. An axially inner end of the engaging piece 97 that is located on a side of a proximal end of the connecting portion 61 is designed to be located at the same axial position as an axially outer wall surface of the annular stop groove 69 that is located on a side of a distal end of the connecting portion 61. The retainer holding portion 67 has a ring-shaped frame body 99 (the same as the ring-shaped frame body 81 except configuration on an inner circumferential surface side). The ring-shaped frame body 99 has an inner circumferential surface 101 (passage aperture) that has an inner diameter generally equal to an inner diameter of the connecting hole 59 (more specifically, an end portion of the connecting hole 59 near its outer opening, an engaging recess 77 is not formed on a circumference of the outer opening thereof) or slightly larger than an inner diameter of the connecting hole 59 (or an inner diameter generally equal to an outer diameter of the connecting portion 61, more specifically, a proximal end portion of the connecting portion 61 extending from the annular stop groove 69 in a proximal direction (toward the proximal end thereof), or an inner diameter slightly larger than an outer diameter of the proximal end portion of the connecting portion 61 extending from the annular stop groove 69 in the proximal direction (toward the proximal end thereof). The inner circumferential surface 101 is formed with eight engaging recesses 103 (second engaging portions, engaging recessed portions) equally spaced in a circumferential direction. Each of the engaging recesses 103 is configured to engage with the engaging piece 97 formed in the connecting portion 61 of the quick connector 63. That is, the engaging recesses 103 are formed in a circumferentially spaced relation at 45° in the inner circumferential surface 101 along an entire circumference thereof. Each of the engaging recesses 103 is formed so as to open at an outer surface or surface of the ring-shaped frame body 99, an inner surface of the ring-shaped frame body 99 (a surface facing the outer surface of the cap 5) and the inner circumferential surface 101 of the ring-shaped frame body 99, and extends radially for a length or radial length generally equal to projecting length of the engaging piece 97, and has a thickness generally equal to that of the engaging piece 97. Meanwhile, the ring-shaped frame body 99 is designed to have a thickness or height generally equal to the height of the engaging piece 97.

The quick connector 63 adapted in the third connector mounting structure is mounted to the cap 5 of the fuel pump 3 in a following manner. The connecting portion 61 is inserted in the connecting hole 59 such that the engaging piece 97 is fitted in the engaging recess 103 corresponding to the mounting angle of the connecting portion 61 and the engaging piece 97 and the engaging recess 103 (positioning means or positioning mechanism) are engaged in a circumferential direction. According to a mounting method that may be adapted in the third connector mounting structure, the wire retainer 65 is first moved to a retracted position, the connecting portion 61 of the quick connector 63 is inserted in and connected to the connecting hole 59, and then the wire retainer 65 is returned to the engaged position. However, in the third connector mounting structure, also applicable is such method that insertion of the connecting portion 61 of the quick connector 63 is initiated while the wire retainer 65 is located in the engaged position. According to this method, the connecting portion 61 is being inserted in the connecting hole 59 while pushing apart the arms 93, 93 of the wire retainer 65 and sliding along between the arms 93, 93. In such mounting mode, when the connecting portion 61 is correctly inserted in and connected to the connecting hole 59, the arms 93, 93 of the wire retainer 65 that are pushed apart resiliently return to their original shape into the annular stop groove 69 to snap-engage in the annular stop groove 69.

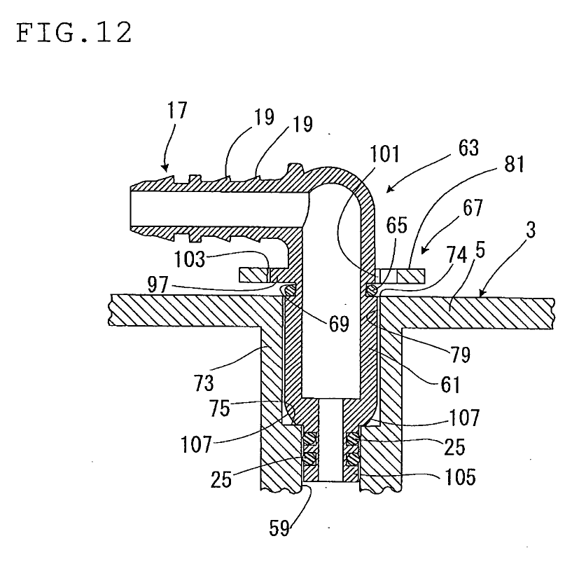

Meanwhile, when the latter mounting method is applied, there is a fear that when the connecting portion 61 slides along between the arms 93, 93, O-rings 25, 25 are hardly rubbed by the arm 93, and consequently damaged or moved off the annular fit-in groove 23. In order to avoid such inconvenience, for example, O-rings 25, 25 may be disposed in an inner circumference of the connecting portion 61 in a manner as shown in FIG. 5. This construction does not allow the O-rings 25, 25 to contact with the arms 93, 93 of the wire retainer 65. Or, as shown in FIG. 12, a sealing portion 105 may be formed integrally in the proximal end portion (axially inner end portion) of the connecting portion 61. The sealing portion 105 has an outer diameter smaller than a distance between the arms 93, 93 of the wire retainer 65. The O-rings 25, 25 may be fitted on the outer circumference of the sealing portion 105 to provide a seal between the sealing portion 105 and the connecting hole 59, more specifically, between the sealing portion 105 and a small-diameter inner portion of the connecting hole 59 away from the outer opening thereof. Such construction allows to insert the connecting portion 61 of the quick connector 63 in the connecting hole 59 by preventing the O-rings 25, 25 from contacting with the arms 93, 93 of the wire retainer 65 or from hardly contacting with the arms 93, 93. As shown in FIG. 12, in order to help the arms 93, 93 of the wire retainer 65 to spread apart easily, it is advisable that an outer circumference of the proximal end portion (or the proximal edge portion) or of the axially inner end portion (or axially inner edge portion) of the connecting portion 61 (if the sealing portion 105 is provided, an outer circumference of the proximal end portion of the connecting portion 61 except the sealing portion 105) is formed with a tapered portion 107 that diametrically contracts in a direction of the proximal end or axially inner end, or an arcuate section portion 107 that has a section swelling outwardly in a direction of the distal end or axially outer end.

The connector mounting structure according to the present invention that is adapted, for example, to a fluid piping of a motor vehicle, achieves a reliable piping construction that extends properly.

What is claimed is:

1. A connector mounting structure, comprising:
a fluid line component provided with a connecting hole,
a connector mounted to the fluid line component, the connector being inserted in the connecting hole and fixed to the fluid line component by a lock mechanism so as not to come out of the connecting hole, the connector having a cylindrical connecting portion inserted in and connected to the connecting hole and a tube fit-on portion formed bent on a distal end of the connecting portion,
a positioning mechanism arranged between the connecting portion of the connector and the fluid line component, the positioning mechanism having a first engaging portion provided in the connecting portion of the connector and a second engaging portion provided in the fluid line component, the first engaging portion and the second engaging portion engaging with one another in a circumferential direction so as to position the connecting portion of the connector nonrotatably relative to the connecting hole in the circumferential direction,
the positioning mechanism being constructed to allow to position the connecting portion relative to the connecting hole in the circumferential direction selectively at any one of a number of mounting angular positions,
the second engaging portion being formed in the connecting hole so as to be located on a rim portion of an opening of the connecting hole or below the rim portion of the opening, and
a rim of the opening of the connecting hole being level with or generally level with a surface around a periphery of the opening.

2. A connector mounting structure, comprising:
a fluid line component provided with a connecting hole,
a connector mounted to the fluid line component, the connector being inserted in the connecting hole and fixed to the fluid line component by a lock mechanism so as not to come out of the connecting hole, the connector having a cylindrical connecting portion inserted in and connected to the connecting hole and a tube fit-on portion formed bent on a distal end of the connecting portion,
a positioning mechanism arranged between the connecting portion of the connector and the fluid line component, the positioning mechanism having a first engaging portion provided in the connecting portion of the connector and a second engaging portion provided in the fluid line component, the first engaging portion and the second engaging portion engaging with one another in a circumferential direction so as to position the connecting portion of the connector nonrotatably relative to the connecting hole in the circumferential direction,
the positioning mechanism being constructed to allow to position the connecting portion relative to the connecting hole in the circumferential direction selectively at any one of a number of mounting angular positions, and
the second engaging portion being formed in the connecting hole so as to be located on a position level with or generally level with a surface around a periphery of an opening of the connecting hole, or at lower level than the surface around the periphery of the opening.

3. A connector mounting structure, comprising:
a fluid line component provided with a connecting hole,
a connector mounted to the fluid line component, the connector being inserted in the connecting hole and fixed to the fluid line component by a lock mechanism so as not to come out of the connecting hole, the connector having a cylindrical connecting portion inserted in and connected to the connecting hole and a tube fit-on portion formed bent on a distal end of the connecting portion,
a positioning mechanism arranged between the connecting portion of the connector and the fluid line component, the positioning mechanism having a first engaging portion provided in the connecting portion of the connector and a second engaging portion provided in the fluid line component, the first engaging portion and the second engaging portion engaging with one another in a circumferential direction so as to position the connecting portion of the connector nonrotatably relative to the connecting hole in the circumferential direction,
the positioning mechanism being constructed to allow to position the connecting portion relative to the connecting hole in the circumferential direction selectively at any one of a number of mounting angular positions,
the lock mechanism having an annular stop projecting portion formed on the outer circumference of the connecting portion of the connector, a retainer holding portion formed on a periphery of the opening of the connecting hole in the fluid line component, and a retainer located between the retainer holding portion and the annular stop projecting portion that seats in a large-diameter fit-in portion formed in an opening portion of the connecting hole in order to fix the annular stop projecting portion,
the first engaging portion being provided on or adjacent to a surface of the annular stop projecting portion facing a proximal end of the connecting portion, and
the second engaging portion being provided in an annular bottom surface of the fit-in portion of the connecting hole.

4. The connector mounting structure as set forth in claim 3, wherein the annular stop projecting portion seats in the fit-in portion so that a surface of the annular stop projecting portion facing the distal end of the connecting portion is co-planar with the surface around the periphery of the opening of the connecting hole.

5. A connector mounting structure, comprising:
a fluid line component provided with a connecting hole,
a connector mounted to the fluid line component, the connector being inserted in the connecting hole and fixed to the fluid line component by a lock mechanism so as not to come out of the connecting hole, the connector having a cylindrical connecting portion inserted in and connected to the connecting hole and a tube fit-on portion formed bent on a distal end of the connecting portion,
a positioning mechanism arranged between the connecting portion of the connector and the fluid line component, the positioning mechanism having a first engaging portion provided in the connecting portion of the connector and a second engaging portion provided in the fluid line component, the first engaging portion and the second engaging portion engaging with one another in a circumferential direction so as to position the connecting portion of the connector nonrotatably relative to the connecting hole in the circumferential direction,
the positioning mechanism being constructed to allow to position the connecting portion relative to the connecting hole in the circumferential direction selectively at any one of a number of mounting angular positions,
the lock mechanism having an annular or generally annular retainer holding portion formed on a periphery of an opening of the connecting hole in the fluid line component and provided with a passage aperture, and a retainer held in the retainer holding portion while engaging with the connecting portion that is inserted in and connected to the connecting hole through the passage aperture to lock the connecting portion,
the first engaging portion being formed in an outer circumference of the connecting portion of the connector, and
the second engaging portion being formed in the passage aperture of the retainer holding portion.

6. The connector mounting structure as set forth in claim 1, wherein the first engaging portion is an engaging protrusion or engaging recessed portion, and the second engaging portion is an engaging recessed portion or engaging protrusion to mate with the first engaging portion.

7. The connector mounting structure as set forth in claim 5, wherein the first engaging portion is an engaging protrusion or engaging recessed portion, and the second engaging portion is an engaging recessed portion or engaging protrusion to mate with the first engaging portion.

8. The connector mounting structure as set forth in claim 1, wherein the first engaging portion is an engaging protrusion and the second engaging portion is an engaging recessed portion to fit on the engaging protrusion.

9. The connector mounting structure as set forth in claim 5, wherein the first engaging portion is an engaging protrusion and the second engaging portion is an engaging recessed portion to fit on the engaging protrusion.

10. A connector mounting structure, comprising:
a fluid line component provided with a connecting hole,
a connector mounted to the fluid line component, the connector being inserted in the connecting hole and fixed to the fluid line component by a lock mechanism so as not to come out of the connecting hole, the connector having a cylindrical connecting portion inserted in and connected to the connecting hole and a tube fit-on portion formed bent on a distal end of the connecting portion,
a positioning mechanism arranged between the connecting portion of the connector and the fluid line component, the positioning mechanism having an engaging protrusion provided in the connecting portion of the connector and an engaging recessed portion provided in the fluid line component, the engaging protrusion and the engaging recessed portion engaging with one another in a circumferential direction so as to position the connecting portion of the connector nonrotatably relative to the connecting hole in the circumferential direction,
the engaging recessed portion being formed in the connecting hole so as to be located on a rim portion of an opening of the connecting hole or below the rim portion of the opening, and
a rim of the opening of the connecting hole being level with or generally level with a surface around a periphery of the opening, and
a number of the engaging recessed portions being provided in the circumferential direction, the engaging protrusion engaging with any one of the engaging recessed portions selectively.
